(19) United States
(12) Patent Application Publication
(10) Pub. No.: US 2008/0050093 A1
(43) Pub. Date: Feb. 28, 2008

(54) Broadcast signal receiving apparatus

(75) Inventors: Tatsuo Koga, Daito City (JP); Yuji Yamamoto, Yawata City (JP)

Correspondence Address: MOTS LAW, PLLC, 1001 PENNSYLVANIA AVE. N.W., SOUTH, SUITE 600, WASHINGTON, DC, 20004, US

(73) Assignee: SANYO ELECTRIC CO., LTD., Moriguchi City (JP)

(21) Appl. No.: 11/892,350

(22) Filed: Aug. 22, 2007

(30) Foreign Application Priority Data
Aug. 28, 2006 (JP) JP2006-230402

(51) Int. Cl. H04N 5/91

(52) U.S. Cl. 386/95

(57) ABSTRACT

When a video signal and an audio signal obtained through decoding by a decoder 14 are outputted for the playback of a broadcast program, a scene identification code generator 20 generates and outputs a scene identification code by which to identify the scene currently being played back.

This application is based on Japanese Patent Application No. 2006-230402 filed on Aug. 28, 2006, the contents of which are hereby incorporated by reference.

### BACKGROUND OF THE INVENTION

1. Field of the Invention

The present invention relates to a broadcast signal reception apparatus for receiving a broadcast signal such as one of a television broadcast, and more particularly to a broadcast signal reception apparatus capable of playing back and recoding video and audio based on a broadcast signal.

2. Description of Related Art

In recent years, with advancements in the digitization of television broadcast and in the introduction of high-speed communication over high-speed networks such as those based on fiber optics, various kinds of broadcast communication such as television broadcast have come to enjoy multifaceted services exploiting the Internet and the like. One of such services is the distribution of EPGs (electronic program guides)—timetables of broadcast programs (broadcast schedules) in the form of electronic data. With a broadcast schedule distributed as an EPG displayed on a broadcast signal reception apparatus that has received it, a user can, on the broadcast schedule thus displayed, select a broadcast program of his choice for timed-recording or playback (see JP-A-2006-080801).

Even from before the introduction of broadcast schedules distributed as EPGs, there has been a service that allows a user to select a broadcast program of his choice easily for timed-recording or playback by entering into a broadcast signal reception apparatus a G-Code (registered trademark)—a numerical code of up to eight digits that appears along with the title of the broadcast program on a newspaper or magazine. As an extension to this, there have been proposed mobile terminal devices that can take in a G-Code (registered trademark) as an image with an image-taking device such as a camera, then analyze the image to recognize the code, and then program the timed-recording of the broadcast program identified by the numerical code thus recognized (see JP-A-2005-260672).

A broadcast program can be identified on an EPG or by a G-Code (registered trademark), indeed, but not a particular scene in a broadcast program. In the first place, the G-Code (registered trademark) system is designed for the timed-recording of broadcast programs, and is not intended for use in reading already recorded broadcast programs. Thus, conventionally, to search for a desired scene in an already recorded broadcast program, it is necessary to first identify the broadcast program based on its “broadcast date, broadcast station, and broadcast time” and then search it for the desired scene by fast forwarding or skipping operations.

Today, there are also available XML (extensible Markup Language) files that contain “broadcast date, broadcast station, broadcast start time of a scene, and broadcast end time” in the form of text. Even with a recording apparatus capable of reading a desired scene from an already recorded broadcast program by use of such an XML file, however, to generate a file for identifying a given scene, it is necessary to enter text.

Likewise, also when a user who has viewed the text in such an XML file wants to use the text, which consists of the “broadcast date, broadcast station, broadcast start time of a scene, and broadcast end time” specifying a desired scene, to identify the scene on another recording apparatus, it is necessary to enter text. Inconveniently, if a remote control unit is used here, it needs to be equipped with keys for the entry of text, which make the remote control unit large; moreover, to identify a scene, a user is obliged to go through complicated operations.

### SUMMARY OF THE INVENTION

In view of the inconveniences mentioned above, it is an object of the present invention to provide a broadcast signal reception apparatus that can generate a simple code by which to identify a given scene in a broadcast program.

To achieve the above object, according one aspect of the present invention, a broadcast signal reception apparatus is provided with: a tuner portion that receives and demodulates a broadcast signal; a decoder portion that decodes the broadcast signal demodulated by the tuner portion to output a playback signal, which is visible; and a scene identification code generator portion that generates a scene identification code by which a scene being played back from the playback signal is identified, based on the channel on which the broadcast signal is selected and on the broadcast date and time of the scene.

With this configuration, when broadcast contents are reproduced from the received broadcast signal, a scene identification code by which to identify a given scene can be generated within the apparatus. Delivering a thus generated scene identification code to another user permits this user, by using the scene identification code, to start playback at a given scene. Here, a scene consists of one or more frames that are played back consecutively; for example, a scene consists of a series of frames that are played back consecutively in a predetermined period. A scene that is identified by a scene identification code is a scene at a particular moment identified by, for example, the broadcast time. A scene identification code is the information by which a scene can be identified, and is in the form of a value or the like.

According to the present invention, it is possible to generate a scene identification code by which a scene is identified. By use of such a scene identification code, it is possible to easily search for a given scene in a broadcast signal recorded in the apparatus itself or in another apparatus.

### BRIEF DESCRIPTION OF THE DRAWINGS

FIG. 1 is a block diagram showing the configuration of a hard disk recorder as an example of a broadcast signal reception apparatus according to the present invention;

FIG. 2 is a flow chart showing the recording procedure of the hard disk recorder of FIG. 1;

FIG. 3 is a flow chart showing a first example of the scene identification code generating procedure of the hard disk recorder of FIG. 1;

FIG. 4 is a flow chart showing a second example of the scene identification code generating procedure of the hard disk recorder of FIG. 1;

FIG. 5 is a flow chart showing a third example of the scene identification code generating procedure of the hard disk recorder of FIG. 1;

FIG. 6 is a flow chart showing the scene identification code analyzing procedure of the hard disk recorder of FIG. 1;

FIG. 7 is a flow chart showing the scene identification code encoding procedure;

FIG. 8 is a flow chart showing the scene identification code decoding procedure;

FIG. 9 is a diagram illustrating Example 1 employing a broadcast signal reception apparatus embodying the present invention;

FIG. 10 is a diagram illustrating Example 2 employing a broadcast signal reception apparatus embodying the present invention;

FIG. 11 is a diagram illustrating Example 3 employing a broadcast signal reception apparatus embodying the present invention; and

FIG. 12 is a diagram illustrating Example 4 employing a broadcast signal reception apparatus embodying the present invention.

### DETAILED DESCRIPTION OF PREFERRED EMBODIMENTS

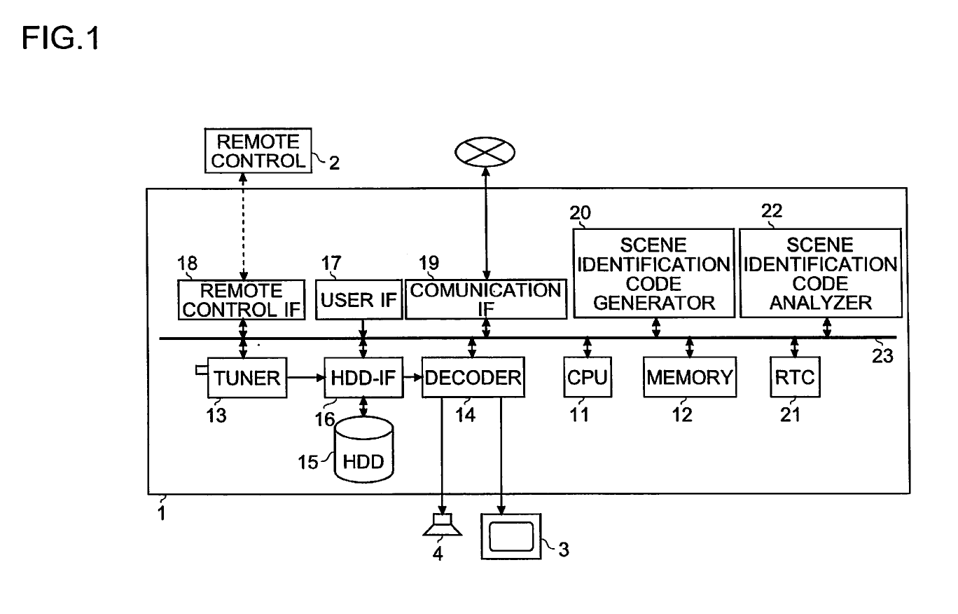

Hereinafter, an embodiment of the present invention will be described with reference to the accompanying drawings. The embodiment presented bellow deals with, as an example of a broadcast signal reception apparatus, a hard disk recorder capable of recording received broadcast programs. FIG. 1 is a block diagram showing the internal configuration of the hard disk recorder of this embodiment.

The hard disk recorder 1 shown in FIG. 1 includes: a CPU 11 for overall control; a memory 12 for storing programs executed by the CPU 11 and temporary calculation results obtained during calculations; a tuner portion 13 for demodulating a received broadcast signal on a desired channel to produce a TS (transport stream); a decoder portion 14 for decoding the TS according to a coding method such as the MPEG2 (Moving Picture Experts Group-2) method to produce a video signal and an audio signal; a hard disk drive (HDD) 15 for recording the TS produced by the tuner portion 13; a HDD interface (HDD-IF) 16 for controlling the recording to the hard disk drive 15; a user interface 17 (user IF) for receiving direct inputs from a user; a remote control interface (remote control IF) 18 for receiving inputs from the user through wireless communication using infrared rays or the like; a communication interface (communication IF) 19 for communicating over the Internet via a router or modem; a scene identification code generator portion 20 for generating a scene identification code by which a given scene in a received broadcast program is identified; a real-time clock (RTC) 21 for counting the current time; a scene identification code analyzer portion 22 for analyzing a scene identification code; and a bus line 23 for the exchange of signals among the individual blocks.

Now the different procedures of the hard disk recorder 1 configured as described above will be described.

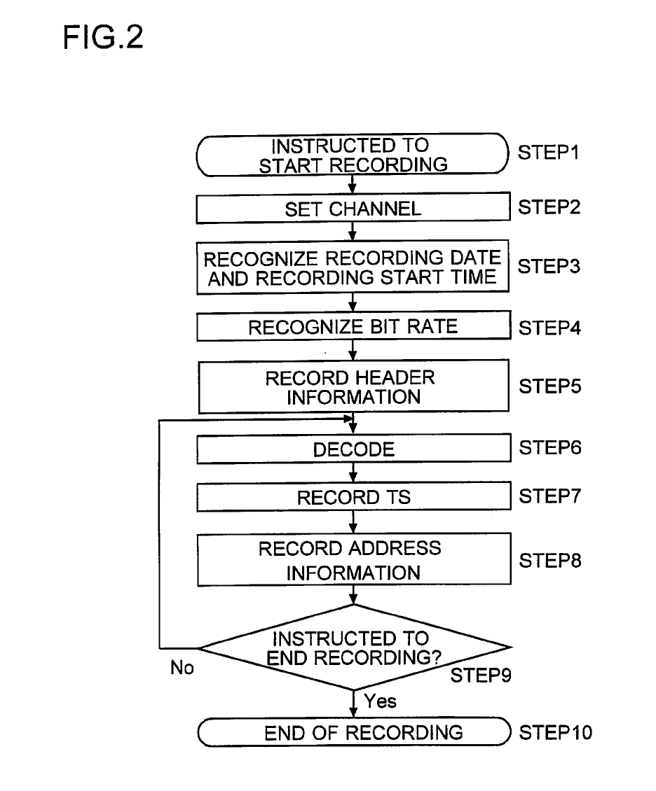

Recording Procedure First, the recording procedure of the hard disk recorder 1 will be described with reference to the flow chart in FIG. 2. When an instruction to start the recording procedure is entered as a result of the user IF 17 being operated or the remote control IF 18 receiving an infrared signal from a remote control unit 2 (STEP1), the CPU 11 recognizes the channel, specified at the same time that the instruction to start the recording procedure is entered, of the broadcast program to be recorded (STEP2). Thus, the channel frequency selected by the tuner portion 13 is changed to that of the desired channel, and the broadcast signal starts to be received.

At this point, the current time and date as counted by the RTC 21 are recognized as the recording start time and the recording date, which are fed to the HDD-IF 16 (STEP3). Moreover, in the tuner portion 13, which receives the broadcast signal, when the broadcast signal of the channel frequency corresponding to the desired channel starts to be selected, the information of the channel of which the selection is desired and the bit rate of the TS obtained are fed to the HDD-IF 16 (STEP4). Then, in the HDD-IF 16, header information consisting of the recording start time, the recording date, the selected channel, and the bit rate is generated, and is written, as the header information of the TS obtained by the tuner portion 13, to the HDD 15 (STEP5).

Now that the desired channel starts to be selected in this way, the tuner portion 13 demodulates the selected broadcast signal according to a demodulation method such as QPSK (quadrature phase shift keying) or QAM (quadrature amplitude modulation) to obtain the TS of the desired channel (STEP6). When the TS thus obtained is fed to the HDD-IF 16, it is written to the HDD IS by the HDD-IF 16 (STEP7). When the TS, which has been given the head information by the HDD-IF 16, is written to the HDD 15 in this way, the address information of the region at which the TS is written to the HDD 15 is recorded in an address information table within the memory 12 (STEP8).

Thereafter it is checked whether or not an instruction to end the recording procedure is entered as a result of the user IF 17 being operated or the remote control IF 18 receiving an infrared signal from a remote control unit 2 (STEP9). If no instruction to end the recording procedure is entered (No), then, in STEP6, the recording of the TS obtained by the tuner portion 13 is continued. If the CPU II recognizes an instruction to end the recording procedure (Yes), the reception by the tuner portion 13 and the writing to the HDD 15 by the HDD-IF 16 are ended and thus the recording procedure is ended (STEP10).

Although the above description deals with a case where the recording procedure is started and ended in response to instructions from the user, the same procedure applies equally in a case where a schedule for timed recording of a broadcast program is stored in the memory 12. Specifically, when a broadcast program included in the schedule stored in the memory 12 is recognized to have a recording start time that coincides with the current time counted by the RTC 21, the tuner portion 13 is made to select the channel frequency corresponding to the channel of that broadcast program, and the recording procedure is started; thereafter, when, based on the schedule stored in the memory 12, the recording end time of the broadcast program is recognized to coincide with the current time counted by the RTC 21, the recording procedure is ended.

Playback Procedure: Next, the playback procedure of the hard disk recorder 1 will be described. It should be noted that, in the following description, a “recorded broadcast program” is referred to simply as a “broadcast program”. When an instruction to start the playback procedure is entered as a result of the user IF 17 being operated or the remote control IF 18 receiving an infrared signal from a remote control unit 2 (STEP1), the CPU 11 recognizes the broadcast program of which the playback is desired. Then the address information table stored in the memory 12 is referred to recognize the address on the HDD 15 at which the broadcast program of which the playback is desired is recorded. Then the HDD-IF 16 is instructed to read from the HDD 15 the TS recorded at the recognized address.

After the HDD-IF 16 reads from the HDD 15 the TS recorded at the address specified by the CPU 11, it feeds it to the decoder portion 14. The decoder portion 14 then decodes the TS fed from the HDD-IF 16 according to a compression coding method such as the MPEG2 method to produce the video and audio signals of the broadcast program whose playback is desired. The video and audio sign thus produced are then fed to a display 3 and a speaker 4, where the video and audio of the broadcast program that the user wants to playback are played back.

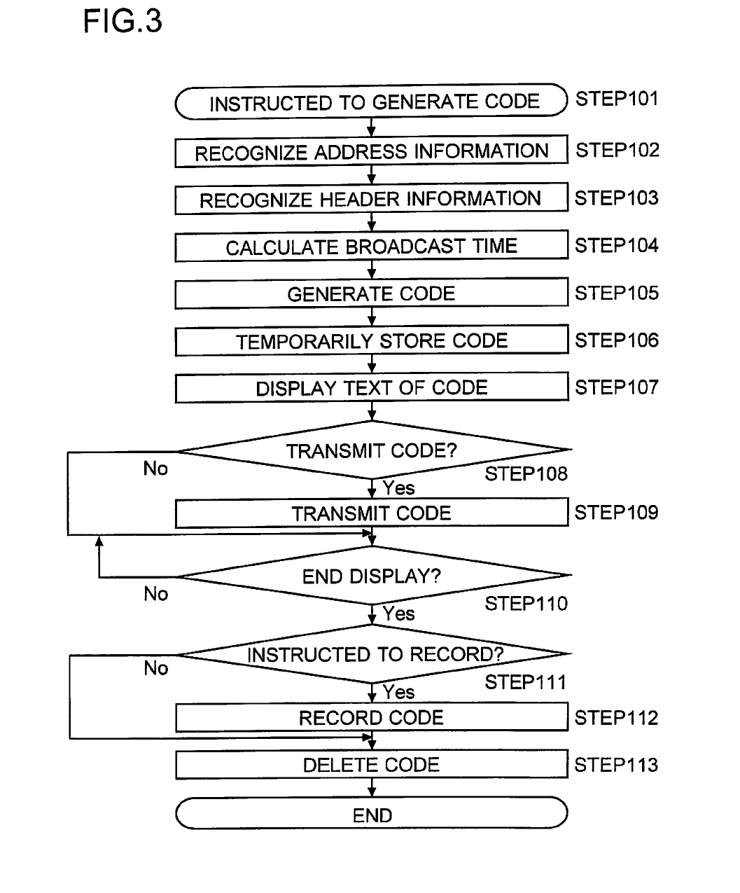

First Example of Scene Identification Code Generating Procedure: While the playback procedure described above is underway, when an instruction to generate a scene identification code is entered as a result of the user IF 17 being operated or the remote control IF 18 receiving an infrared signal from the remote control unit 2, the scene identification code generator portion 20 generates a scene identification code by which the scene that is currently being played back is identified. Now a first example of the scene identification code generating procedure will be described with reference to the flow chart of FIG. 3.

When the CPU 11 recognizes that an instruction to generate a scene identification code is entered (STEP101), first the scene identification code generator portion 20 recognizes, from the address information table, the address information of the TS corresponding to the scene currently being played back (the scene address) and the address information of the recording start position of the TS being played back (the recording start address) (STEP102). Thereafter the scene identification code generator portion 20 recognizes, from the header information of the TS of the broadcast program currently being played back, the recording start time, recording date, channel information, and bit rate of the broadcast program (STEP103). The header information may be read out from the HDD 15 and temporarily stored in the memory 12 at the start of playback, or may be read out from the HDD 15 anew.

Then, based on the recording start time and bit rate of the broadcast program recognized in STEP103 and the scene address and the recording start address recognized in STEP102, the CPU 11 performs calculations to calculate the broadcast time of the current, identified scene (STEP104). Here, the scene identification code generator portion 20 can calculate the broadcast time of the current scene according to, for example, formula (1) below. In formula (1), T and Ts represent the broadcast time and recording start time, respectively, of the scene; A and As represent the scene address and the recording start address, respectively; and br represents the bit rate.
T=Ts+(A−As)/br (1)

After the scene broadcast time is calculated in this way, the scene identification code generator portion 20 performs predetermined encoding based on the scene broadcast time thus calculated and the channel information and the recording date recognized in STEP103 to generate a scene identification code (STEP105). The scene identification code thus generated is temporarily stored in the memory 12 (STEP106), and is then fed to the decoder portion 14, so as to be integrated into the decoded video signal and then fed to the display 3, where, along with the video of the broadcast program, the text of the scene identification code is displayed (STEP107). Here, the hard disk recorder 1 itself may be provided with a display so that the scene identification code is displayed on this display of the recorder itself.

Then it is checked whether or not an instruction to transmit the scene identification code temporarily stored in the memory 12 is entered (STEP108). Here, the decoder portion 14 integrates into the video signal of the broadcast program being reproduced text information asking whether or not to transmit the scene identification code and text information of the scene identification code, so that text asking whether or not to transmit the scene identification code is displayed on the display 3. Then whether or not to transmit the scene identification code is determined by the user operating the user IF 17 or the remote control unit 2.

Here, if the user is recognized to enter an instruction to transmit the scene identification code (Yes), the scene identification code temporarily stored in the memory 12 is, by being attached to e-mail or uploaded, transmitted to a predetermined communication destination such as a predetermined server (STEP109). Thereafter, if an instruction not to transmit the scene identification code has been entered in STEP108 (No), or if the scene identification code has been transmitted in STEP109, it is checked whether or not an instruction to end the display of the scene identification code on the display 3 is entered (STEP110).

If an instruction to end the display of the scene identification code is recognized to be entered as a result of the user IF 17 or the remote control unit 2 being operated (Yes), it is checked whether or not to record the scene identification code to the HDD 15 (STEP111). The checking in STEP110 is continued until an instruction to end the display of the scene identification code is entered as a result of the user IF 17 or the remote control unit 2 being operated; also when the playback of the broadcast program is ended, or when an instruction to turn the power of the hard disk recorder 1 off is entered, an advancement to STEP111 may be made.

Then, in STEP111, the decoder portion 14 integrates into the video signal of the broadcast program being reproduced text information asking whether or not to record the scene identification code and text information of the scene identification code, so that text asking whether or not to record the scene identification code is displayed on the display 3. Then whether or not to record the scene identification code is determined by the user operating the user IF 17 or the remote control unit 2.

If, in STEP111, an instruction to record the scene identification code is recognized to be entered (Yes), the HDD-IF 16 records the scene identification code, along with information to be linked with the address information of the scene being played back, in a predetermined region on the HDD 15 (STEP112). Thereafter, if, in STEP111, an instruction not to record the scene identification code is recognized to be entered (No), or when, in STEP112, the recording of the scene identification code is completed, the scene identification code temporarily stored in the memory 12 is deleted (STEP113), the procedure is ended.

In this example, the procedure is performed only when the user enters an instruction to generate a scene identification code. Thus, for the desired scene specified by the user, a scene identification code can be generated and displayed so as to be recognized by the user. In a case where it is transmitted from the communication IF 19, it can be uploaded to a predetermined server, or mailed to a predetermined communication destination; in a case where it is recorded to the HDD 15, it can be displayed without being calculated anew from the next time on.

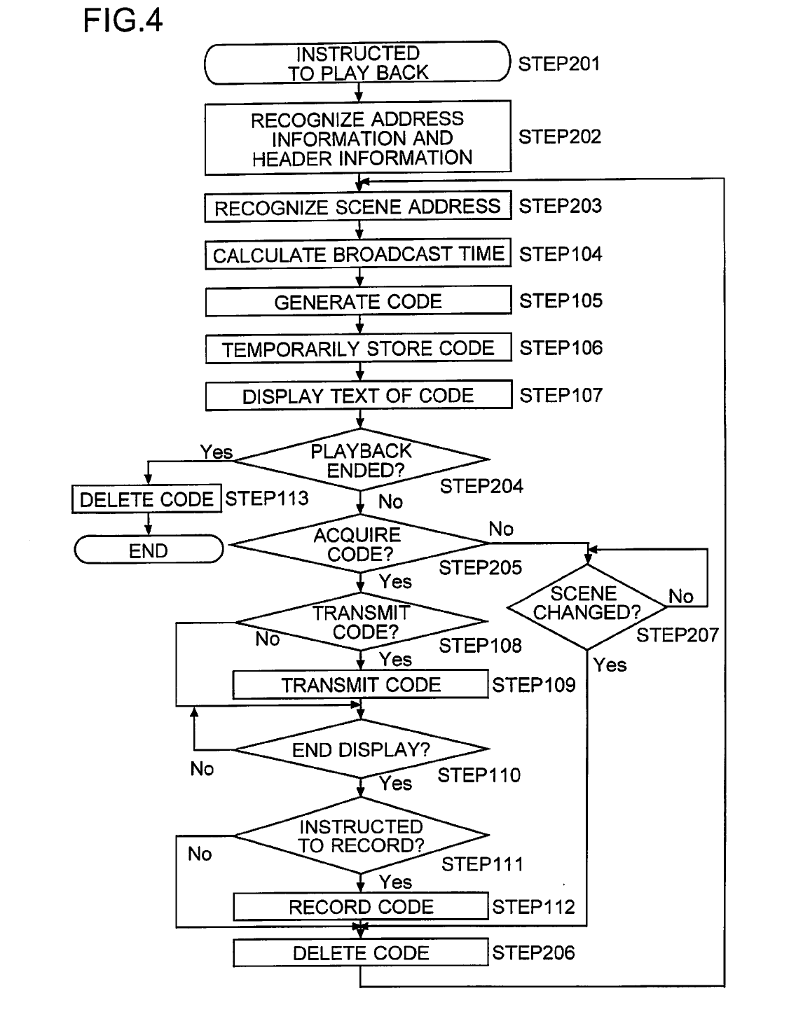

Second Example of Scene Identification Code Generating Procedure: In the first example described above, a scene identification code is generated after an instruction to generate one is entered. In this example, by contrast, whenever a scene is being played back, a scene identification code is generated. Now this scene identification code generating procedure will be described with reference to the flow chart in FIG. 4. In the flow chart in FIG. 4, those steps in which the same operations as in the flow chart in FIG. 3 are performed are identified by common step numbers, and their detailed description will not be repeated.

When a user is recognized to enter an instruction to start playback from the user IF 17 or the remote control unit 2 (STEP201), the video and audio of the broadcast program are played back, and concurrently, for each scene played back, a scene identification code is generated. To achieve this, first, the scene identification code generator portion 20 temporarily stores the recording start time, recording date, channel information, bit rate, and recording start address of the broadcast program (STEP202). At this point, the CPU 11 recognizes, based on the header information of the TS of the broadcast program, the recording start time, recording date, channel information, and bit rate of the broadcast program of which the playback is started, and also recognizes, from the address information table in the memory 12, the recording start address; the CPU 11 then feeds these to the scene identification code generator portion 20.

Then the scene identification code generator portion 20 recognizes the scene address from the address information table in the memory 12 (STEP203). Thereafter the broadcast time of the current scene is calculated, and a scene identification code is generated; then, the scene identification code is temporarily stored in the memory 12, and is fed to the decoder portion 14 so as to be displayed on the display 3 (STEP104 to STEP107). Then the CPU 11 checks whether or not an instruction to end the playback procedure is entered (STEP204).

Here, if no instruction to end the playback procedure is entered from the user IF 17 or the remote control unit 2 (No), it is checked whether or not the user enters an instruction to request the acquisition of the scene identification code (STEP205). If the CPU 11 recognizes that an instruction to request the acquisition of the scene identification code is entered from the user IF 17 or the remote control unit 2 (Yes), it is checked whether or not an instruction to transmit the scene identification code is entered; if an instruction to transmit is entered, the scene identification code is transmitted from the communication IF 19 (STEP108 and STEP109).

Thereafter, when an instruction to end the display of the scene identification code on the display 3 is recognized to be entered and thus the display is instructed to be ended, it is checked whether or not to record the scene identification code to the HDD 15 (STEP110 and STEP111). Then, if an instruction to record the scene identification code is recognized to be entered (Yes), the scene identification code is recorded in a predetermined region on the HDD 15 (STEP112), and then the scene identification code temporarily stored in the memory 12 is deleted (STEP206). By contrast, if, in STEP111, an instruction not to record the scene identification code is entered (No), an advancement is made directly to STEP206. In this way, when the scene identification code is deleted from the memory 12 in STEP206, then, in STEP203, the scene identification code for the next scene is generated.

If, in STEP205, no instruction to request the acquisition of the scene identification code is entered (No), the CPU 11 checks whether or not the scene has changed to the next one (STEP207). Here, the change to the next scene may be recognized based on the passage of a predetermined length of playback time, or based on the playback of a predetermined number of frames. When the change to the next scene is recognized, an advancement is made to STEP206, where the scene identification code in the memory 12 is deleted; then an advancement to STEP 203 is made, where the scene identification code for the next scene is generated. If, in STEP204, an instruction to end the playback procedure is recognized (Yes), the scene identification code temporarily stored in the memory 12 is deleted (STEP113), and the procedure is ended.

In this example, for the scene currently being played back, a scene identification code can be generated. This permits the scene identification code for the scene currently played back to be displayed together with it. This, based on the scene identification code displayed, the user can recognize the scene identification code corresponding to the scene that is currently being played back. In a case where it is transmitted from the communication IF 19, it can be uploaded to a predetermined server, or mailed to a predetermined communication destination; in a case where it is recorded to the HDD 15, it can be displayed without being calculated anew from the next time on.

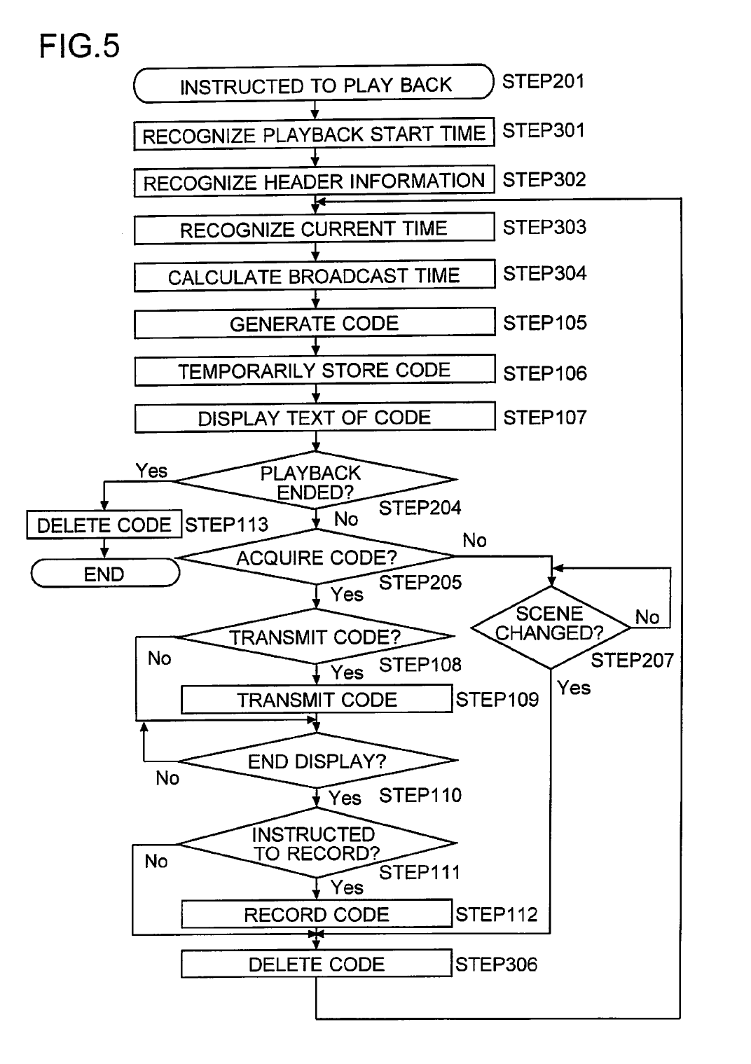

Third Example of Scene Identification Code Generating Procedure: In the first and second examples described above, when the broadcast time of a scene is acquired through calculations, it is calculated based on address information. In this example, by contrast, it is obtained by recognizing the time counted by the RTC 21. Now this scene identification code generating procedure will be described with reference to the flow chart in FIG. 5. In the flow chart in FIG. 5, those steps in which the same operations as in the flow chart in FIG. 4 are performed are identified by common step numbers, and their detailed description will not be repeated.

In this example, as in the second example, when a user is recognized to enter an instruction to start playback from the user IF 17 or the remote control unit 2 (STEP201), the video and audio of the broadcast program are played back, and concurrently, for each scene played back, a scene identification code is generated. To achieve this, first, the scene identification code generator portion 20 recognizes the current time from the RTC 21, and temporarily stores it as the playback start time (STEP301). Thereafter, the scene identification code generator portion 20 temporarily stores the recording start time, recording date, channel information, and bit rate of the broadcast program (STEP302). At this point, the CPU 11 recognizes, based on the header information of the TS of the broadcast program of which the playback is started, the recording start time, recording date, and channel information of the broadcast program, and feeds these to the scene identification code generator portion 20.

Then the scene identification code generator portion 20 acquires the current time from the RTC 21 (STEP303), and then calculate the broadcast time of the current scene based on the playback start time stored in STEP 201, the current time acquired in STEP303, and the recording start time of the broadcast program (STEP304). Here, the scene identification code generator portion 20 can calculate the broadcast time of the current scene according to, for example, formula (2) below. In formula (2), the broadcast time, recording start time, and playback start time of the scene and the current time are represented by T, Ts, T1, and T2, respectively.
T=Ts+(T2−T1) (2)

Thereafter, a scene identification code is generated based on the broadcast time thus calculated; it is then temporarily stored in the memory 12, and is fed to the decoder portion 14 so as to be displayed on the display 3 (STEP105 to STEP107). Then, the CPU 11 checks whether or not an instruction to end the playback procedure is entered (STEP204). The operations that are performed after STEP204 are the same as in the second example except that, in STEP306, the scene identification code is deleted from the memory 12 and then an advancement is made to STEP303.

In this example, a scene identification code can be generate based on the time counted by the RTC 21. This eliminates the need for calculations using the header information of the TS read out for playback as required in the first and second examples described previously, and thus helps simplify the calculation of the broadcast time of the current scene.

In the scene identification code generating procedure of any of the three examples described above, while the scene identification code corresponding to the scene specified by the user is being displayed, the playback procedure of the video and audio may be paused at the scene specified by the user, or may be continued as usual. In a case where the playback procedure is continued as usual, in the second and third examples described above, the display of the scene identification code, which is refreshed from one scene to another otherwise, is paused. In the third example described above, as in the second example described above, a scene identification code is generated for every scene played back, and a scene identification code is acquired when the user enters an instruction to do so; alternatively, as in the first example described above, a scene identification code may be generated and acquired only when the user enters an instruction to do so.

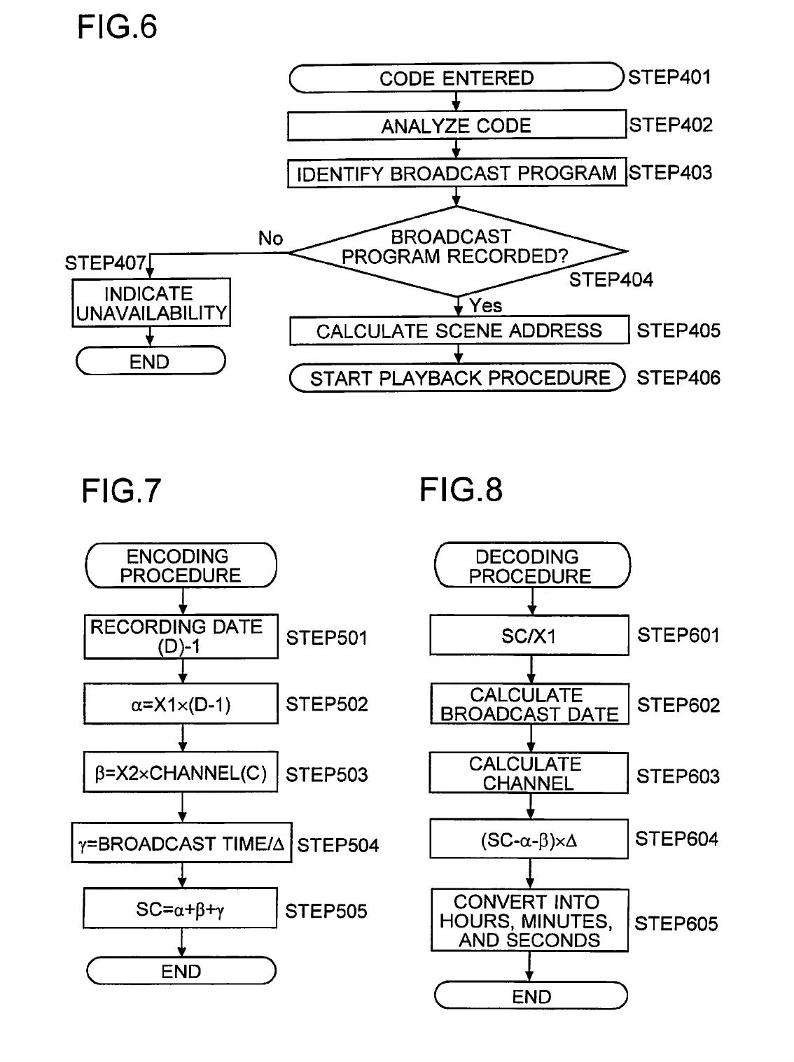

Scene Identification Code Analyzing Procedure: Now the procedure performed when a scene identification code obtained as described above is entered so that playback is started at the scene identified by the scene identification code will be described with reference to the flow chart in FIG. 6. First, the entry of a scene identification code is recognized by the CPU 11 (STEP401). The entry of the scene identification code here may be achieved directly by the user IF 17 being operated, or by the remote control IF 18 receiving an infrared signal from the remote control unit 2, or the communication IF 19 acquiring a scene identification code over the Internet.

When, in STEP401, a scene identification code is recognized to be entered, the scene identification code analyzer portion 22 analyzes the entered scene identification code and thereby acquires the broadcast time, channel information, and broadcast date (this corresponds to the recording date at the time of recording) of the scene identified by the scene identification code (STEP402). Then, based on the thus identified broadcast time, channel information, and broadcast date, the scene identification code analyzer portion 22 identifies the broadcast program containing the scene identified by the scene identification code (STEP403). Here, for example based on an EPG acquired beforehand, the broadcast start time and broadcast end time of a given broadcast program are recognized: by confirming that the identified broadcast time falls between the broadcast start time and broadcast end time of the given broadcast program, this broadcast program is identified.

When the broadcast program is identified in STEP403, whether or not the identified broadcast program is recorded on the HDD 15 is checked via the HDD-IF 16 (STEP404). Here, the recording date, recording start time, and channel information of every broadcast program recorded on the HDD 15 are checked to see whether any broadcast program is recorded whose recording date and channel information coincide with the broadcast date and channel information of the broadcast program identified in STEP403 and whose recording start time falls between the broadcast start time and broadcast end time identified in STEP403; in this way, whether or not the identified broadcast program is on the HDD 15 is checked.

If the identified broadcast program is recognized to be recorded on the HDD 15 (Yes), then, based on the relationship between the broadcast time of the scene as recognized in STEP403 and the broadcast start time of the broadcast program as recognized in STEP404, the scene identification code analyzer portion 22 calculates the scene address at which the identified scene is recorded on the HDD 15 (STEP405).

Here, first, the recording start address on the HDD 15 from which the identified broadcast program is recorded is recognized from the address information table. Then, based on the header information of the TS corresponding to the broadcast program, the recording start time and the bit rate are recognized, and then, through calculation according to formula (3) below, the scene address at which the identified scene is recorded is recognized. In formula (3), the broadcast time and recording start time of the scene are represented by T and Ts, respectively; the scene address and the recording start address are represented by A and As, respectively; and the bit rate is represented by br.
A=As+(T−Ts)×br (3)

After the scene address of the identified scene is calculated in this way, the TS recorded at the address on the HDD 15 identified by the scene address is read out by the HDD-IF 16, and playback is started at the identified scene (STEP406). If, in STEP404, the identified broadcast program is not recorded on the HDD 15 (No), a message indicating that no broadcast program containing the identified scene is recorded is displayed on, for example, the display 3 to notify the user of the fact (STEP407), and the procedure is ended.

Instead of identifying the broadcast program in STEP403, it is also possible, in STEP404, to check whether or not a broadcast program containing the scene identified by the scene identification code is recorded on the HDD 15 based on the recording date, channel information, recording start time, and recording end time of the broadcast programs recorded on the HDD 15. In this case, with respect to a broadcast program on the HDD 15 whose recording date and channel information coincide with the broadcast date and channel information of the broadcast program containing the scene identified by the scene identification code, whether or not the bit rate of the latter falls between the recording start time and recording end time of the former is checked, and thereby whether or not the identified broadcast program is recorded on the HDD 15 is checked.

First Example of Scene Identification Code: Now a first example of the method whereby a scene identification code, generated and analyzed as described above, is encoded and decoded will be described. FIG. 7 is a flow chart illustrating the encoding procedure for generating a scene identification code, and FIG. 8 is a flow chart illustrating the decoding procedure for analyzing a scene identification code. In this example, it is assumed that, of the year, month, and day constituting the recording date, only the day is used, and that the channel is one of the numbers from 01 to 99. It is also assumed that the change from one scene to another takes place every A seconds. Specifically, for example, suppose that scenes change every three seconds, then the total number of scenes that occur per day is calculated as follows: 24 hours×60 minutes×60 seconds/3 seconds=28800 scenes.

First, a description will be given of the encoding procedure of the scene identification code generator portion 20 in this example. As shown in FIG. 7, first, 1 is subtracted from the recording date (D) to calculate (D−1), which takes a value in the range from 00 to 30 (STEP501). This value (D−1) calculated from the recording date is then multiplied by a constant X1 (in the example where scenes change every three seconds, 2880000) to calculate a variable a (=X1×(D−1)) that depends on the recording date (STEP502). Let the number of scenes per day be Sx and the number of digits in the value representing the channel be N, then the coefficient X1 here is given by X1=Sx×10^{N}.

Next, the channel (C) is multiplied by a constant X2 (in the example where scenes change every three seconds, 28800) to calculate a variable β (=X2×C) that depends on the channel (STEP503). Let the number of scenes per day be Sx, then the coefficient X2 here is given by X2=Sx. Then the broadcast time (H hours, M minutes, and S seconds) is converted into seconds, and is then divided by the scene change interval Δ (seconds) to calculate a variable γ (=(H×3600+M×60+S)/Δ) (STEP504). Lastly, the variables α, β, and γ are added up to acquire a scene identification code (=α+β+γ) (STEP505).

For example, suppose that the recording date is “day 4”, the channel is “channel 8”, and the broadcast time is “12 hours 34 minutes 15 seconds”, first, in STEP501, 4−1=3 is calculated and then, in STEP502, α=3×2880000=8640000 is calculated. Then, in STEP503, β=8×28800=230400 is calculated and, in STEP405, γ=(12×3600+34×60+15)/3=15085 is calculated. Then α, β, and γ thus calculated are added up to obtain a scene identification code SC having the value of 8885484.

Next, a description will be given of the decoding procedure of the scene identification code generator portion 20 in this example. As shown in FIG. 8, when a scene identification code SC is entered, first, it is divided by the constant X1 (STEP601), and then 1 is added to the quotient to acquire the broadcast date (D) (STEP602). Then the remainder β+γ (=SC−α) of the division in STEP 601 is divided by the constant X2 to obtain, from the quotient, the channel (C) (STEP603). Further, the remainder γ (=SC−α−β) of the division in STEP603 is multiplied by the scene change interval Δ to acquire a time in seconds (STEP 604), which is then converted into a time in hours, minutes, and seconds to thereby obtain a broadcast time (H hours, M minutes, and S seconds) (STEP605).

For example, when a scene identification code SC having the value of 8885485 is entered, in STEP601, it is divided by X1=2880000 and then, in STEP602, 1 is added to the quotient to obtain the broadcast date “day 4”. Then, in STEP603, the remainder β+γ of the division in STEP601, namely 245485, is divided by X2=28800 to obtain, as the quotient, 8, that is, “channel 8”. Lastly, in STEP604, the remainder γ of the division in STEP603, namely 15085, is divided by the scene change interval, namely 3 seconds, to acquire a single-unit value 45255. This is then converted in STEP605 to obtain the broadcast time “12 hours 34 minutes 15 seconds”.

Second Example of Scene Identification Code: In the first example described above, of the year, month, and day of the broadcast date, only the day is encoded into the scene identification code. Instead, the year, month, and day may all be encoded as in this example. In that case, the scene identification code may be composed of, for example, upper digits into which the year and month are encoded and lower digits—separated from the upper digits—into which the day, the channel, and the broadcast time are encoded in the manner described above.

With respect to the year and month, for example in a case where one hundred years from the year 2000 to the year 2099 are dealt with, the upper digits—depending on the year and month—of the code can be generated by multiplying the last two digits of the year by 13 and then adding the month to the product. Specifically, for the year 2016, month 10 (October), the last two digits “16” of the year 2016 is multiplied by 13 to obtain a value of 208, to which “10” of the month is then added to generate a code “218”. This can be combined with the code described previously that depends on the day, the channel, and the broadcast time, for example “8885485”, to obtain a scene identification code “218-8885485”, by which the broadcast year and month can be identified as well.

Third Example of Scene Identification Code: The scene identification code may be generated based on a G-Code (registered trademark). Specifically, a scene identification code may be generated by adding information representing the scene broadcast time to a G-Code (registered trademark). In that case, a code representing in seconds the difference between the broadcast start time of the broadcast program as identified by the O-Code (registered trademark) and the scene broadcast time may be added as digits separate from the G-Code (registered trademark).

Moreover, the broadcast start time specified by the G-Code (registered trademark) may be replaced with the start time of a particular scene, and the recording duration specified by the G-Code (registered trademark) may be replaced with correction information for correcting the start time of the particular scene. In that case, by correcting the start time of the particular scene by adding to it the time represented by the correction information, it is possible to acquire the correct broadcast time of the particular scene. A G-Code (registered trademark) permits a recording duration up to 480 minutes to be specified in 5-minute increments, thus allowing one of 96 different recording durations to be set. Accordingly, replacement with correction information in 3.125-second increments permits correction up to 300 seconds (=5 minutes), thus allowing a G-Code (registered trademark) to specify the broadcast start time in 5-minutes increments.

The scene identification code composed, as described above, of the broadcast date, the channel, and the broadcast time may further contain scene playback duration information that indicates the playback duration of the scene. In that case, the scene playback duration information may be encoded into a separate digit in the code so as to be easily extractable, or may be combined into the code as in the example described above. Although the above description deals with a case where the broadcast time is used as information for identifying the scene identified by a scene identification code, it is also possible to use any information other than the broadcast time so long as it helps identify at how manieth place in the broadcast program the scene occurs.

Example of Procedure Associated with Chapters: When a desired scene is identified through generation and analysis of a scene identification code as described above, in this embodiment, a scene identification code is generated for a scene identified by a user. In a case where a broadcast program recorded on the HDD 15 is recorded along with chapter points indicating scene change points and start/end points of commercial messages, scene identification codes may be generated in association with such chapter points.

In that case, for example if the difference between the broadcast time of an identified scene and the broadcast time of the scene indicated by the chapter point played back immediately before the identified scene is within a predetermined length of time, the scene identification code generator portion 20 may generate a scene identification code indicating the immediately previous chapter point. In this way, a scene identification code is generated that specifies the chapter containing the scene identified by the user; thus, at the time of playback based on this scene identification code, it is easier to grasp the contents of the identified scene. It is also possible to permit choice between: encoding by conversion into a scene identification code based on the chapter point immediately before the scene identified by the user; and encoding into a scene identification code representing the scene identified by the user.

Alternatively, the scene identification code analyzer portion 22 may search for the chapter point immediately before the broadcast time of the scene identified by analyzing an inputted scene identification code so that, if the difference between the broadcast time of the chapter point thus found and the broadcast time of the scene as identified by the scene identification code is within a predetermined length of time, playback is started at the chapter point found. It is also possible to permit choice between: starting playback at the scene identified by the scene identification code; and starting playback at the chapter point immediately before the scene identified by the scene identification code.

The embodiment deals with a hard disk recorder as a representative of broadcast signal recording/playback apparatuses; in a case where only the capability of generating a scene identification code is needed, it can be achieved by providing a scene identification code generator portion for a broadcast signal reception apparatus, such as a television receiver, that is provided with a tuner portion for receiving a broadcast signal. On the other hand, a broadcast signal recording/playback apparatus may be provided with a scene identification code analyzer portion alone so as to be capable of recognizing and playing back a scene identified by an inputted scene identification code.

A few examples of how to apply the scene identification code according to the embodiment will be described below.

### Example 1

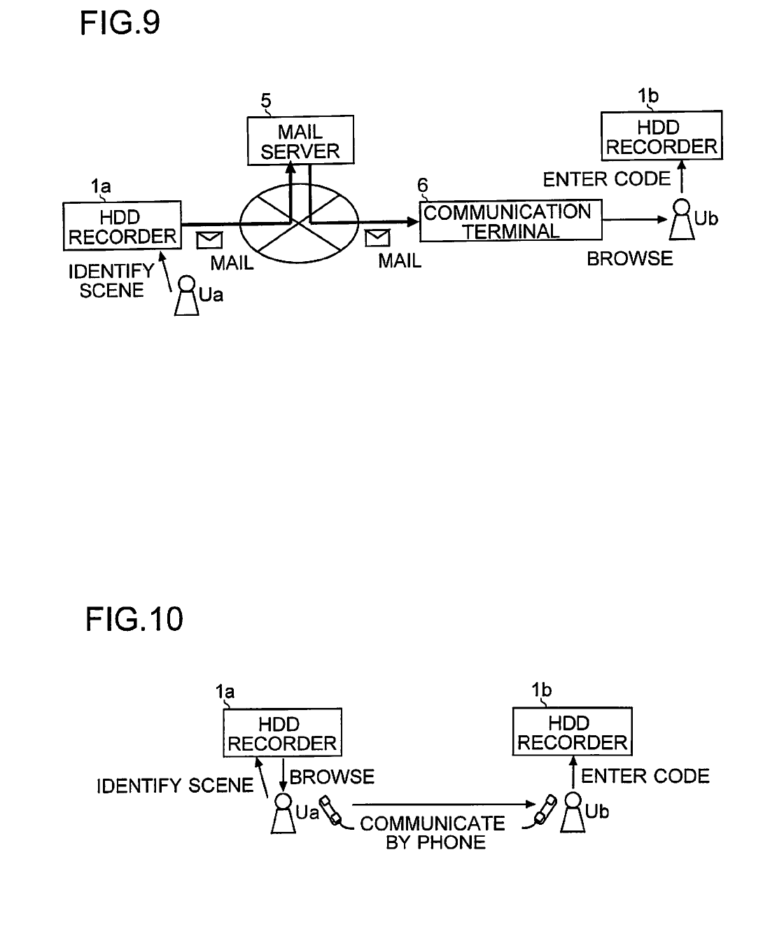

In this example, as shown in FIG. 9, a hard disk recorder 1a is connected to the Internet so that e-mail having a scene identification code attached to it can be transmitted. Here, when the user Ua of the hard disk recorder 1a enters data for identifying a scene, the hard disk recorder 1a generates a scene identification code representing the identified scene. Then e-mail having the scene identification code attached to it is transmitted from the hard disk recorder 1a over the Internet to the mail server 5 that serves the user Ub of a hard disk recorder 1b.

By using a communication terminal 6, such as a mobile phone or personal computer, that can be connected to the Internet, the user Ub receives the e-mail stored in the mail server 5; as the user Ub browses it, he recognizes the scene identification code attached to it. The user Ub then enters the scene identification code recognized while browsing the e-mail into the hard disk recorder 1b, which then starts playback at the scene identified by the scene identification code.

In this example, the hard disk recorder 1 can automatically send a scene identification code, in the form attached to e-mail, to the user Ub. Then, by entering the received scene identification code into the hard disk recorder 1b, the user Ub can easily start the playback of the scene identified by the scene identification code.

### Example 2

In this example, as shown in FIG. 10, users Ua and Ub communicates with each other by telephone to transmit a scene identification code by voice. Here, when the user Ua, who possesses a hard disk recorder 1a, enters data for identifying a scene, the hard disk recorder 1a generates and displays a scene identification code that identifies the scene. Recognizing the scene identification code thus displayed, the user Ua calls up the user Ub and transmits the scene identification code by voice. The user Ub then enters the scene identification code received by telephone into a hard disk recorder 1b, which then starts playback at the scene identified by the scene identification code.

In this example, users Ua and Ub transmit a scene identification code between them through communication using telephones; instead, a corporation may send a post card carrying a scene identification code to the user Ub, who then recognizes the scene identification code indicated on the post card. In that case, having recognized the scene identification code on the post card, the user Ub enters it into the hard disk recorder 1b to start playback. Here, the scene identification code may be indicated in the form of a bar code so that, by analyzing the scene identification code recognized in response to the input of the bar code, the scene to be played back is recognized.

In this example, the users Ua and Ub can let each other know a scene identification code by communicating it by use of one of various types of medium. Then, by entering the received scene identification code into a hard disk recorder 1a or 1b, the scene identified by the scene identification code can easily be played back.

### Example 3

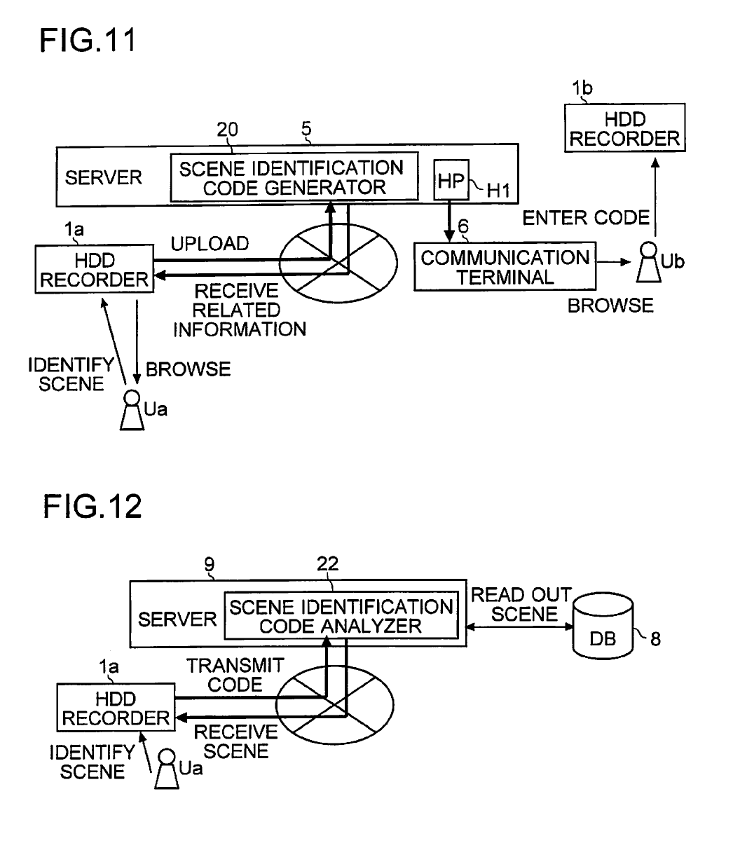

In this example, as shown in FIG. 11, a server 6 is provided with a scene identification code generator portion 20 and, in a database 7 in which a Web page H1 of the site managed by the server 6 is stored, a scene identification code generated by the server 6 and information related to the scene identified by that scene identification code are stored. Stored as the information related to the scene are: comments by people who watched the scene; URLs of sites at which information on merchandise or personality appearing in that scene is available; etc.

Here, when the user Ua, who possesses a hard disk recorder 1a that can be connected to the Internet, enters data for identifying a scene that he wants to acquire information related to, the hard disk recorder 1a generates a scene identification code, which is then transmitted to the server 6. The server 6 then reads out from the database 7 information related to the scene identified by the received scene identification code, and transmits it back to the hard disk recorder 1a. As a result, on the hard disk recorder 1, the scene identified by the user Ua is played back in the form merged with the information related to it. Here, if the related information thus played back contains a URL and the user Ua specifies it, the Web page at that URL can be displayed.

Moreover, at the Web page H1 of the site managed by the server 5, the scene identification code generated by the server 5 and the information related to the scene identified by that scene identification code are posted. Thus, by using a communication terminal 6, the user Ub, who possesses a hard disk recorder 1b, can browse the Web page H1 managed by the server 5 and recognize the scene identification code posted there. Then, by entering the scene identification code recognized by browsing the Web page H1 into the hard disk recorder 1b, it is possible to make the hard disk recorder 1b start playback at the scene identified by the scene identification code.

In this example, by transmitting a scene identification code to the server 5, the hard disk recorder 1a can receive and play back information related to the scene identified by the scene identification code, and thus its user can obtain information related to the desire scene. Moreover, by browsing the Web page H1, it is possible to recognize the scene identification code easily; thus, by entering the scene identification code thus recognized into the hard disk recorder 1b, it is possible to play back the desired scene easily.

### Example 4

In this example, as shown in FIG. 12, a server 9 provided with a database 8 having all broadcast programs recorded in it is on the Internet, and this server 9 is provided with a scene identification code analyzer portion 22. Here, when a user Ua enters a scene identification code into his hard disk recorder 1a, if the broadcast program containing the scene identified by that scene identification code is not recorded on the HDD 15, the entered scene identification code is transmitted to the server 9.

In response, the server 9 analyses, with the scene identification code analyzer portion 22, the scene identification code received from the hard disk recorder 1a and recognizes the scene identified by the scene identification code. Then, to enable the hard disk recorder 1a to start playback at the recognized scene, the server 9 reads out from the database 8 and transmits to the hard disk recorder 1a the TS of the broadcast program containing the recognized scene, starting with the TS of the recognized scene until an instruction to end is received.

Thus, the hard disk recorder 1a can receive the TS starting at the scene identified by the scene identification code and start playback at the identified scene. The TS received from the server 9 may be temporarily stored on the HDD 15 only during playback, or may be kept stored on the HDD 15 even after playback.

In this example, in the TS recorded in the database 8, with respect to the TS of overlapping scenes having different broadcast times, only the TS of the more recently broadcast scene may be recorded. In that case, overlapping scenes are managed via a table in which are recorded the scene identification codes of the overlapping scenes having different broadcast times and information on the address in the database 8 at which those scenes are recorded.

In this example, even if the TS of the scene identified by a scene identification code is not recorded in the hard disk recorder 1a, when the scene identification code is transmitted to the server 9, the TS of the scene identified by the scene identification code recognized by the server 9 is transmitted back from the server 9. Thus, even if the TS of the scene identified by a scene identification code is not recorded in the hard disk recorder 1a, the TS can be received from the server 9 and played back.

The present invention finds applications in broadcast signal recording/playback apparatuses such as hard disk recorders and DVD recorders and in broadcast signal reception apparatuses such as television sets.

What is claimed is:

1. A broadcast signal reception apparatus comprising:
a tuner portion receiving and demodulating a broadcast signal;
a decoder portion decoding the broadcast signal demodulated by the tuner portion to output a playback signal, which is visible; and
a scene identification code generator portion generating a scene identification code by which a scene being played back from the playback signal is identified, based on a channel on which the broadcast signal is selected and on a broadcast date and time of the scene.

2. The broadcast signal reception apparatus according to claim 1,
wherein, every time a scene is played back from the playback signal outputted from the decoder portion, the scene identification code generator portion generates the scene identification code.

3. The broadcast signal reception apparatus according to claim 1,
wherein, when a scene is being played back from the playback signal outputted from the decoder portion, on receiving an instruction to generate the scene identification code for the scene currently being played back, the scene identification code generator portion generates the scene identification code.

4. The broadcast signal reception apparatus according to claim 1, further comprising:
a recording medium recording the broadcast signal demodulated by the tuner portion; and
a recording medium controller portion controlling writing to and reading from the recording medium,
wherein, in a case where the playback signal is outputted as a result of the broadcast signal recorded on the recording medium being fed to the decoder portion, when the scene identification code generator portion generates the scene identification code, the scene identification code generator portion determines the broadcast date and time of the to-be-identified scene based on a recording start date and time of a broadcast program that contains the scene was started and a relative time of the to-be-identified scene as counted from a start scene of the recorded broadcast program.

5. The broadcast signal reception apparatus according to claim 4, further comprising:
a scene identification code analyzer portion analyzing the scene identification code to thereby recognize the broadcast program and the scene that are identified by the scene identification code,
wherein, when the scene identification code analyzer portion recognizes the broadcast program and the scene that are identified by the inputted scene identification code, if the broadcast signal corresponding to the broadcast program identified by the scene identification code is recorded on the recording medium, part of the broadcast signal corresponding to the scene identified by the scene identification code is read by the recording medium controller portion reads and fed to the decoder portion.

6. The broadcast signal reception apparatus according to claim 4,
wherein the scene identification code generator portion calculates the relative time of the to-be-identified scene as counted from the start scene of the identified broadcast program based on a bit rate at which the broadcast program is recorded on the recording medium.

7. The broadcast signal reception apparatus according to claim 6, further comprising:
a scene identification code analyzer portion analyzing the scene identification code to thereby recognize the broadcast program and the scene that are identified by the scene identification code,
wherein, when the scene identification code analyzer portion recognizes the broadcast program and the scene that are identified by the inputted scene identification code, if the broadcast signal corresponding to the broadcast program identified by the scene identification code is recorded on the recording medium, part of the broadcast signal corresponding to the scene identified by the scene identification code is read by the recording medium controller portion reads and fed to the decoder portion.

8. The broadcast signal reception apparatus according to claim 1, further comprising:
an interface for communication with an external communication network,
wherein the scene identification code generated by the scene identification code generator portion is transmitted from the interface to another communication apparatus connected via the communication network.

9. The broadcast signal reception apparatus according to claim 8,
wherein the interface receives information related to the scene identified by the scene identification code from another communication apparatus connected via the communication network.
